(19) United States
(12) Patent Application Publication
(10) Pub. No.: US 2022/0332235 A1
(43) Pub. Date: Oct. 20, 2022

(54) VEHICLE SEAT

(71) Applicant: FAURECIA Sièges d'Automobile, NANTERRE (FR)

(72) Inventors: Sophia BENNIS, PARIS (FR); Anne-Isabelle MALLET-DA COSTA, ETRECHY (FR)

(21) Appl. No.: 17/722,745

(22) Filed: Apr. 18, 2022

(30) Foreign Application Priority Data
Apr. 19, 2021 (FR) 2104066

(51) Int. Cl. B60N 2/90; B60N 2/20; B60N 2/70

(52) U.S. Cl. CPC B60N 2/914; B60N 2/20; B60N 2/70; B60N 2002/981; B60N 2/976

(57) ABSTRACT

A vehicle seat comprising: a seat base comprising a rigid frame, a flexible covering layer, as well as a cushioning layer interposed between the flexible covering layer and the frame, a backrest comprising a rigid frame, a flexible covering layer, as well as a cushioning layer interposed between the flexible covering layer and the frame, and a haptic system, comprising: at least one independent set each comprising at least one pneumatic haptic element, positioned at the backrest and/or the seat base, and at least one independent set each comprising at least one electromechanical haptic element, positioned at the backrest and/or the seat base.

### PRIORITY CLAIM

This application claims priority to French Patent Application No. FR2104066, filed Apr. 19, 2021, which is expressly incorporated by reference herein.

### BACKGROUND

The present disclosure relates to a vehicle seat, and in particular a motor vehicle seat, a method for controlling such a vehicle seat, as well as a vehicle comprising such a vehicle seat.

### SUMMARY

According to the present disclosure, a vehicle seat comprises

a seat base intended to be fixed to the floor of a vehicle, and comprising a rigid frame, a flexible covering layer intended to receive and support the legs and/or buttocks of a user, as well as a cushioning layer interposed between the flexible covering layer and the frame,

a backrest pivotably hinged to the seat base along a transverse axis of the seat, and comprising a rigid frame, a flexible covering layer intended to receive and support the back of a user, as well as a cushioning layer interposed between the flexible covering layer and the frame,

a haptic system, comprising:

at least one independent set of pneumatic haptic elements each comprising at least one pneumatic haptic element, positioned at the backrest and/or the seat base, and

at least one independent set of electromechanical haptic elements each comprising at least one electromechanical haptic element, positioned at the backrest and/or the seat base.

In illustrative embodiments, the pneumatic haptic element or elements are expandable elements, intended to increase their volume when a fluid is introduced therein and to decrease their volume when the fluid is extracted therefrom.

In illustrative embodiments, the electromechanical haptic element or elements are vibrating elements, intended to vibrate at a determined frequency and/or amplitude when electrically powered.

In illustrative embodiments, the haptic system comprises at least one independent set of pneumatic haptic elements and/or at least one independent set of electromechanical haptic elements, both positioned at the seat backrest.

In illustrative embodiments, the haptic system comprises a first independent set of pneumatic haptic elements positioned at the seat backrest, in front of the cushioning layer in the longitudinal direction of the seat, and interposed between the flexible covering layer and the cushioning layer of the backrest.

In illustrative embodiments, the pneumatic haptic elements of the first set are, at least in part, aligned in columns each extending substantially in the vertical direction of the seat and/or in rows each extending substantially in the transverse direction of the seat.

In illustrative embodiments, the first set comprises at least eight pneumatic haptic elements, preferably at least twelve pneumatic haptic elements, and even more preferably at least sixteen pneumatic haptic elements.

In illustrative embodiments, the haptic system comprises a second independent set of pneumatic haptic elements positioned at the seat backrest, and: according to a first alternative, positioned behind the cushioning layer in the longitudinal direction of the seat, and interposed between the cushioning layer and the frame, or, according to a second alternative, positioned in front of the cushioning layer in the longitudinal direction of the seat, and interposed between the flexible covering layer and the cushioning layer.

In illustrative embodiments, at least some of the pneumatic haptic elements of the second set of pneumatic haptic elements are fixed on a support part of the backrest, the support part being fixed to the frame and positioned so that the cushioning layer is positioned in front of the support part in the longitudinal direction of the seat, interposed between the flexible covering layer and the support part, the support part being for example a suspension layer of the backrest or being integral with such a suspension layer.

In illustrative embodiments, at least some of the pneumatic haptic elements of the second set extend, at least partially, through the cushioning layer.

In illustrative embodiments, the second set of pneumatic haptic elements is configured as a lumbar support for a user of the seat, the second set comprising in particular three pneumatic haptic elements substantially parallel to each other, with two adjacent pneumatic haptic elements partially superimposed one over the other substantially in the vertical direction of the seat.

In illustrative embodiments, the haptic system comprises a first independent set of electromechanical haptic elements positioned at the seat backrest, and: according to a first alternative, positioned behind the cushioning layer in the longitudinal direction of the seat, and interposed between the cushioning layer and the frame, or, according to a second alternative, positioned in front of the cushioning layer in the longitudinal direction of the seat, and interposed between the flexible covering layer and the cushioning layer.

In illustrative embodiments, at least some of the electromechanical haptic elements of the first set of electromechanical haptic elements are fixed on a support part of the backrest, the support part being fixed to the frame and positioned so that the cushioning layer is positioned in front of the support part in the longitudinal direction of the seat, and interposed between the flexible covering layer and the support part.

In illustrative embodiments, at least some of the electromechanical haptic elements of the first set extend, at least partially, through the cushioning layer.

In illustrative embodiments, the haptic system comprises at least one independent set of pneumatic haptic elements positioned at the seat base of the seat and/or at least one independent set of electromechanical haptic elements positioned at the seat base of the seat.

In illustrative embodiments, the haptic system comprises a third independent set of pneumatic haptic elements positioned at the seat base of the seat, and: according to a first alternative, positioned below the cushioning layer in the vertical direction of the seat, and interposed between the cushioning layer and the frame, or, according to a second alternative, positioned above the cushioning layer in the vertical direction of the seat, and interposed between the flexible covering layer and the cushioning layer.

In illustrative embodiments, at least some of the pneumatic haptic elements of the third set of pneumatic haptic elements are fixed on a support part of the seat base, the support part being fixed to the frame and positioned so that the cushioning layer is positioned above the support part in the vertical direction of the seat, and interposed between the flexible covering layer and the support part.

In illustrative embodiments, at least some of the pneumatic haptic elements of the third set extend, at least partially, through the cushioning layer.

In illustrative embodiments, the third set of pneumatic haptic elements is connected to the first set of pneumatic haptic elements.

In illustrative embodiments, the haptic system comprises a second set of electromechanical haptic elements positioned at the seat base of the seat, and: according to a first alternative, positioned below the cushioning layer in the vertical direction of the seat, and interposed between the cushioning layer and the frame, or, according to a second alternative, positioned above the cushioning layer in the vertical direction of the seat, and interposed between the flexible covering layer and the cushioning layer.

In illustrative embodiments, at least some of the electromechanical haptic elements of the second set of electromechanical haptic elements are fixed to a support part of the seat base, the support part being fixed to the frame and positioned so that the cushioning layer is positioned above the support part in the vertical direction of the seat, and interposed between the flexible covering layer and the support part.

In illustrative embodiments, at least some of the electromechanical haptic elements of the second set extend, at least partially, into the cushioning layer.

In illustrative embodiments, the seat further comprises a control unit connected to the haptic system, the control unit being configured to control the operation of the haptic elements of each of the sets independently so as to act on a user seated on the seat.

In illustrative embodiments, the control unit is configured for: controlling the operation of the pneumatic haptic elements of the at least one set of pneumatic haptic elements as a function of a first characteristic of an audio stream playing near the seat, and/or controlling the operation of the electromechanical haptic elements of the at least one set of electromechanical haptic elements as a function of the first characteristic of the audio stream playing near the seat and/or as a function of a second characteristic, different from the first characteristic, of the audio stream playing near the seat.

In illustrative embodiments, a method is proposed for controlling a seat according to one of the embodiments of the disclosure, comprising at least one step of operating one or more haptic elements of one or more independent sets of haptic elements of the haptic system of a user according to a determined operating sequence, so as to act on a user seated on the seat.

In illustrative embodiments, the step also comprises:

controlling the operation of the pneumatic haptic elements of the at least one set of pneumatic haptic elements as a function of a first characteristic of an audio stream playing near the seat, and/or

controlling the operation of the electromechanical haptic elements of the at least one set of electromechanical haptic elements as a function of the first characteristic of the audio stream playing near the seat and/or as a function of a second characteristic of the audio stream playing near the seat.

In illustrative embodiments, a vehicle equipped with a seat according to one of the embodiments of the disclosure is proposed.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a perspective view of a schematic representation of a seat according to one embodiment of the disclosure;

FIG. 2 shows an exploded perspective view of a schematic representation of a seat according to one embodiment of the disclosure;

FIG. 3 shows a sectional view along line III-III of FIG. 1 of a schematic representation of a seat according to one embodiment of the disclosure;

FIG. 4 shows a schematic representation of part of the elements of a seat according to one embodiment of the disclosure; and

FIG. 5 shows a schematic representation of a method according to one embodiment of the disclosure.

### DETAILED DESCRIPTION

The drawings and the description below contain elements which for the most part are certain in nature. Therefore not only can they serve to provide a better understanding of the disclosure, but they also contribute to its definition, where appropriate.

Throughout this application, the spatial directions are defined as follows:

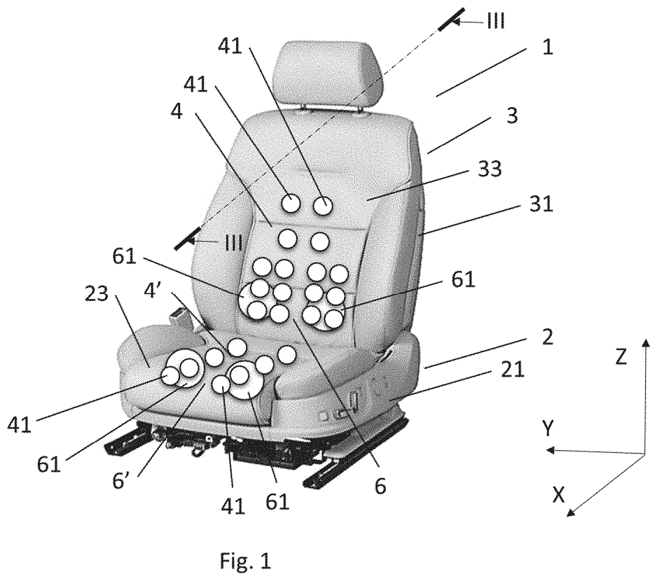

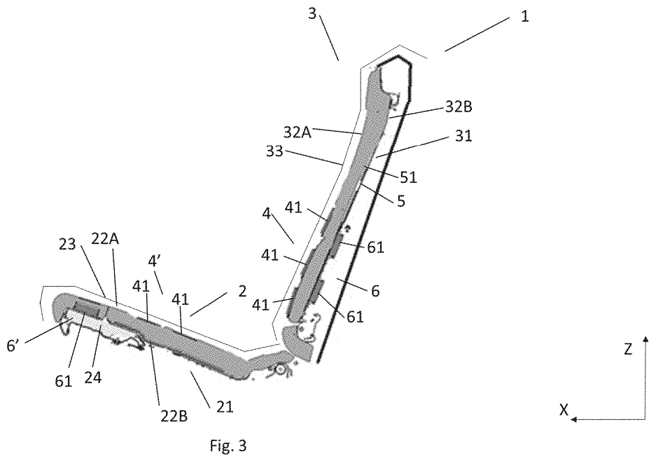

the longitudinal direction X of the seat corresponds to the sliding direction of the seat relative to the floor of the vehicle along slide rails, when the seat comprises slide rails as means of anchoring to the floor of the vehicle, received on the seat base of the seat, as shown in FIGS. 1-3,

the vertical direction Z of the seat corresponds to the direction perpendicular to the plane of the vehicle floor to which the seat is attached, also perpendicular to the longitudinal direction X of the seat, defined above, as shown in FIGS. 1 to 3,

the transverse direction Y of the seat is the direction perpendicular to the longitudinal direction X and vertical direction Z of the seat, as shown in FIGS. 1 to 3.

Similarly, a plane of the seat is defined according to the seat directions it contains.

An axis is defined as a straight line in a determined direction. For example, a transverse axis is an axis along the transverse direction.

Also, front and rear are understood to mean along the longitudinal direction of the seat, with an orientation from the rear edge of the seat, where a seat backrest is generally hinged, towards the front edge of the seat.

Similarly, upper (above) and lower (below) are understood to mean along the vertical direction of the seat, with an orientation from the means of anchoring to the vehicle floor, and in particular the slide rails, towards the seat base of the seat.

Finally, throughout this application, substantially longitudinal, transverse, or vertical are understood to mean an orientation relative to the longitudinal direction, vertical direction, or transverse direction, forming an angle of less than 30°, which may advantageously be zero.

Similarly, substantially parallel is understood to mean an orientation relative to a given element forming an angle of less than 30°, which may advantageously be zero.

As can be seen in FIGS. 1 to 4, the disclosure relates to a vehicle seat 1 comprising:

a seat base 2 intended to be fixed to the floor of a vehicle, and comprising a rigid frame 21, a flexible covering layer 23 intended to receive and support the legs and/or buttocks of a user, as well as a cushioning layer 22, interposed between the flexible covering layer 23 and the frame 21, and in particular in the vertical direction Z of the seat 1,

a backrest 3 pivotably hinged to the seat base 2 along a transverse axis Y1 of the seat 1, and comprising a rigid frame 31, a flexible covering layer 33 intended to receive and support the back of a user, as well as a cushioning layer 32, interposed between the flexible covering layer 33 and the frame 31, and in particular in the longitudinal direction X of the seat 1,

a haptic system H for a user, comprising:

at least one independent set 4, 4′, 5 of pneumatic haptic elements 41, 51 each comprising at least one pneumatic haptic element 41, 51, positioned at the backrest 3 and/or the seat base 2, and

at least one independent set 6, 6′ of electromechanical haptic elements 61 each comprising at least one electromechanical haptic element 61, positioned at the backrest 3 and/or the seat base 2.

Thus, the seat 1 according to the disclosure allows, due to its haptic system H, exerting actions on a user seated on the seat 1, by independently using pneumatic haptic elements 41, 51 of at least one independent set 4, 4′, 5 of pneumatic haptic elements 41, 51 and electromechanical haptic elements 61 of at least one independent set 6, 6′ of electromechanical haptic elements 61.

Each set 4, 4′, 5, 6, 6′ of pneumatic 41, 51 or electromechanical 61 haptic elements is independent in the sense that, unless otherwise specified, these different sets 4, 4′, 5, 6, 6′ are not interconnected and can each operate autonomously, and without the operation of one having an effect on the operation of another.

Also, the haptic elements 41, 51, 61 of each set 4, 4′, 5, 6, 6′ can have an independent operation, in the sense that the operation of one haptic element 41, 51, 61 of a set 4, 4′, 5, 6, 6′ does not influence the operation of another haptic element 41, 51, 61 of the same set 4, 4′, 5, 6, 6′.

It is thus possible for example to carry out an operating sequence in which one or more of the haptic elements 41, 51, 61 of one or more sets 4, 4′, 5, 6, 6′ in a first combination are actuated according to a first determined sequence (i.e. with a certain amplitude of movement or of vibration, and/or with a certain frequency of vibration, and/or with a certain duration of movement or of vibration), the other haptic elements 41, 51, 61 of the haptic system H remaining inactive and having no effect on the body of the user seated on the seat 1, before one or more of the haptic elements 41, 51, 61 of one or more sets 4, 4′, 5, 6, 6′ in a second combination are in turn actuated according to a second determined sequence, the other haptic elements 41, 51, 61 of the haptic system H remaining inactive and having no effect on the body of the user sitting on the seat 1, and so on.

It is advantageously possible in particular to carry out, for example, an operating sequence in which one or more pneumatic haptic elements 41, 51 of one or more sets 4, 4′, 5 of pneumatic haptic elements 41, 51 in a first combination are actuated according to a first determined sequence, the other haptic elements 41, 51, 61, and in particular the set of electromechanical haptic elements 61 remaining inactive and not acting on the body of the user, then in which one or more electromechanical haptic elements 61 of one or more sets 6, 6′ of electromechanical haptic elements 61 in a second combination are actuated according to a second determined sequence, the other haptic elements 41, 51, and in particular the set of pneumatic haptic elements 41, 51 remaining inactive and not acting on the body of the user.

The haptic system H of the seat 1 according to the disclosure allows a coupled action, and advantageously simultaneous or not simultaneous, on the body of a user seated on the seat 1, of pneumatic haptic elements 41, 51 of at least one independent set 4, 4′, 5 and electromechanical haptic elements of at least one independent set 6, 6′. This makes it possible in particular to provide an improved relaxation experience to a user seated on the seat 1.

The haptic system H of the seat 1 thus makes it possible to provide a multisensory haptic experience to a user seated on the seat 1.

For example, comparative measurements carried out on different users using an electroencephalogram (EEG) have made it possible to reveal an improved relaxation for users who have used a seat 1 according to the disclosure, in comparison with other users who have used a seat equipped with pneumatic haptic elements but without electromechanical haptic elements.

Preferably, the electromechanical haptic elements 61 make it possible to exert, on the body of a user seated on the seat 1, an action and in particular a vibrating action, reaching a shallow depth under the user's skin, in particular sub-cutaneous, for example in order to provide a massage to the user seated on the seat 1 and/or a pleasurable sensation.

The pneumatic haptic elements 41, 51 make it possible to exert an action on the body of a user seated on the seat 1, to a greater depth under the user's skin, for example in order to provide a massage to the user seated on the seat 1, and in particular with a draining effect.

In order to facilitate controlling them, some or all of the haptic elements 41, 51, 61 of one or more of the independent sets 4, 5, 5′, 6, 6′ may be interconnected, and in particular electrically.

The frame 31 of the backrest 3 may for example be made essentially of metal.

The cushioning layer 32 of the backrest 3 may for example be a part comprising foam made of polymer, and in particular of polyurethane foam.

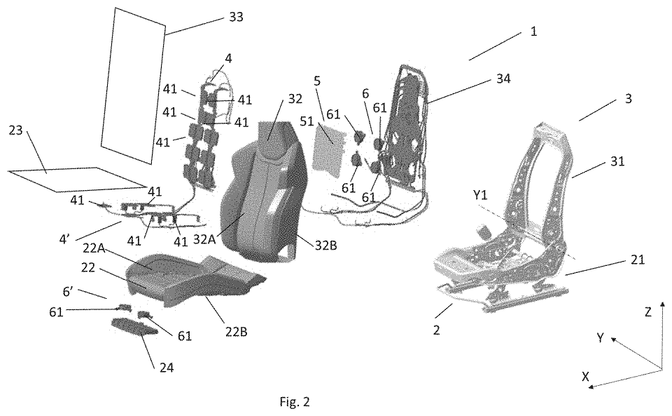

The flexible covering layer 33 of the backrest 3, schematically represented in FIGS. 1 and 2, may for example be made of textile or of leather.

According to one embodiment, the pneumatic haptic element or elements 41, 51 are expandable elements, intended to increase their volume when a fluid is introduced therein and to decrease their volume when the fluid is extracted therefrom.

During their expansion, the pneumatic haptic elements 41, 51 exert pressure on the body of the user, more or less deeply under his or her skin.

Advantageously, the pneumatic haptic elements 41, 51 are connected to means for supplying fluid (not shown), and in particular compressed air.

One or more of the pneumatic haptic elements 41, 51 may for example be implemented in the form of an inflatable and deflatable flexible bag.

According to one embodiment, the electromechanical haptic element(s) 61 are vibrating elements, intended to vibrate at a determined frequency and/or amplitude when electrically powered.

Thus, during their vibration, the electromechanical haptic elements 61 transmit vibrations to the body of the user, which may be provided so as to propagate to a shallow depth under the user's skin.

The electromechanical haptic elements 61 may each comprise at least one electric coil intended to set at least one magnet in motion, in particular a permanent magnet. They may also each comprise a spring, configured to return the magnet to a rest position, in particular at the center of the electric coil.

One or more electromechanical haptic elements 61 may alternatively be implemented in the form of piezoelectric elements.

According to one embodiment, the haptic system H comprises at least one independent set 4, 5 of pneumatic haptic elements 41, 51 and/or at least one independent set 6 of electromechanical haptic elements 61, both positioned at the backrest 3 of the seat 1.

The haptic system H can thus act on the back of a user seated on the seat 1 according to the disclosure.

According to one embodiment, the haptic system H comprises a first independent set 4 of pneumatic haptic elements 41 positioned at the backrest 3 of the seat 1, in front of the cushioning layer 32 in the longitudinal direction X of the seat 1, and interposed between the flexible covering layer 33 and the cushioning layer 32 of the backrest 3, in particular in the longitudinal direction X of the seat 1.

As a result, the pneumatic haptic elements 41 of the first set 4 are as close as possible to the back of the user when seated on the seat 1, so as to act thereon.

Alternatively, and without departing from the scope of the disclosure, the haptic elements 41 of the first set 4 could be located behind the cushioning layer 32 in the longitudinal direction X of the seat 1, and interposed between the cushioning layer 32 and the frame 31 of the backrest 3, in particular in the longitudinal direction X of the seat 1, so as not to transmit movements of excessive amplitude to the user's back, the movements advantageously being at least partially damped by the cushioning layer 32 before reaching the user's back.

Advantageously, the pneumatic haptic elements 41 of the first set 4 may be intended to be located substantially in the extension, in particular in the longitudinal direction X of the seat 1, of the back and/or pelvis and/or shoulders of the user when seated on the seat 1 according to the disclosure.

Advantageously, the pneumatic haptic elements 41 of the first set 4 may be arranged substantially within a same plane, and in particular within a plane substantially in the vertical Z and transverse Y directions of the seat 1.

Advantageously, at least some of the pneumatic haptic elements 41 of the first set 4 may extend at least partially through the cushioning layer 32, so as to reduce the size of the backrest 3 and possibly to allow the cushioning layer 32 to partially dampen the movements of the pneumatic haptic elements 41 of the first set 4 before reaching the user's back.

At least some of the pneumatic haptic elements 41 of the first set 4 may be fixed to the cushioning layer 32, for example by clipping and/or gluing and/or by a hook-and-loop fastening system such as VELCRO® for example. According to one embodiment, the pneumatic haptic elements 41 of the first set 4 are, at least in part, aligned in columns each extending substantially in the vertical direction Z of the seat 1 and/or in rows each extending substantially in the transverse direction Y of the seat 1.

In particular, as can be seen in FIGS. 1 and 2, the pneumatic haptic elements 41 may be arranged in four columns substantially parallel to each other.

The first set 4 can thus cover a large area of the user's back when seated on the seat 1, and while using pneumatic haptic elements 41 of reduced size.

According to one embodiment, the first set 4 comprises at least eight pneumatic haptic elements 41, preferably at least twelve pneumatic haptic elements 41, and even more preferably at least sixteen pneumatic haptic elements 41, and in order to cover the largest possible area of the user's back when seated on the seat 1.

According to one embodiment, and as can be seen in FIGS. 1 to 3, the haptic system H comprises a second independent set 5 of pneumatic haptic elements 51 positioned at the backrest 3 of the seat 1, and:

according to a first alternative, positioned behind the cushioning layer 32 in the longitudinal direction X of the seat 1, and interposed between the cushioning layer 32 and the frame 31, in particular in the longitudinal direction X of the seat 1, so as not to transmit movements of excessive amplitude to the user's back, the movements advantageously being damped, at least in part, by the cushioning layer 32 before reaching the user's back via the flexible covering layer 33, or,

according to a second alternative, positioned in front of the cushioning layer 32 in the longitudinal direction X of the seat 1, and interposed between the flexible covering layer 33 and the cushioning layer 32, in particular in the longitudinal direction X of the seat 1, and so as to be as close as possible to the user's back in order to act thereon.

Advantageously, in order to avoid generating interference between the operation of the pneumatic haptic elements 41 of the first set 4 and the pneumatic haptic elements 51 of the second set 5, the pneumatic haptic elements 41 of the first set 4 may be offset along the longitudinal direction X and/or along the transverse direction Y and/or along the vertical direction Z of the seat 1 relative to the pneumatic haptic elements 51 of the second set 5.

Advantageously, the pneumatic haptic elements 51 of the second set 5 may be arranged substantially within a same plane, and in particular within a plane substantially in the vertical Z and transverse Y directions of the seat 1, and preferably substantially parallel to the pneumatic haptic elements 41 of the first set 4.

According to one embodiment, at least some of the pneumatic haptic elements 51 of the second set 5 of pneumatic haptic elements 51 are fixed to a support part 34 of the backrest 3, the support part being fixed to the frame 31 and positioned so that the cushioning layer 32 is positioned in front of the support part 34 in the longitudinal direction X of the seat 1, interposed between the flexible covering layer 33 and the support part 34, in particular in the longitudinal direction X of the seat 1.

The support part 34 may for example be a suspension layer of the backrest 3 or may be integral with such a suspension layer of the backrest 3; such a suspension layer may be provided to ensure support for the back of the user when seated on the seat 1. The support part 34 may simply consist of a plate, shaped or not shaped, made for example of metal but preferably of plastic.

The cushioning layer 32 may be supported, at least partially, on the support part 34.

In order to reduce the size of the backrest 3, the pneumatic haptic elements 51 of the second set 5 may advantageously extend at least partially, and for at least some of them, through the support part 34.

According to one embodiment, some of the pneumatic haptic elements 51 of the second set 5 extend, at least partially, through the cushioning layer 32, in order to reduce the size of the backrest 3 and possibly enable the cushioning layer 32 to partially dampen the movements of the pneumatic haptic elements 51 of the second set 5 before reaching the user's back and/or shoulders and/or pelvis.

In particular, the pneumatic haptic elements 41 of the first set 4 may be positioned on a first side 32A of the cushioning layer 32, in the longitudinal direction X of the seat 1, and in particular a side 32A facing the front of the seat 1, while the pneumatic haptic elements 51 of the second set 5 may be positioned, in the longitudinal direction X of the seat 1, on a second side 32B of the cushioning layer 32, opposite to the first side 32A in the longitudinal direction X of the seat 1, and in particular a side 32B facing the rear of the seat 1.

Alternatively, the pneumatic haptic elements 41 of the first set 4 may be positioned on the same side 32A, 32B of the cushioning layer 32 as the pneumatic haptic elements 51 of the second set 5.

At least some of the pneumatic haptic elements 51 of the second set 5 may be fixed to the cushioning layer 32, for example by clipping and/or gluing and/or by a hook-and-loop fastening system such as VELCRO® for example.

According to one embodiment, the second set 5 of pneumatic haptic elements 51 is configured in the form of a lumbar support for a user of the seat 1, the second set 5 comprising in particular at least three pneumatic haptic elements 51 substantially parallel to each other, with two adjacent pneumatic haptic elements 51 partially superimposed one over the other substantially in the vertical direction Z of the seat 1.

The second set 5 of pneumatic haptic elements 51 may thus be intended to be positioned, in the longitudinal direction X of the seat 1, substantially in an extension of the spine of a user when seated on the seat 1.

The pneumatic haptic elements 51 may also be movable relative to the frame 31 of the backrest 3, in particular by each being hinged so as to pivot relative to the frame 31 about a substantially transverse axis of the seat 1, and in order to be able to adapt to the morphology of a user seated on the seat 1.

At least some of the pneumatic haptic elements 51 of the second set 5 may also be replaced by one or more suitable lumbar supports.

According to one embodiment, and as can be seen in FIGS. 1 to 4, the haptic system H comprises a first independent set 6 of electromechanical haptic elements 61 positioned at the backrest 3 of the seat 1, and:

according to a first alternative, positioned behind the cushioning layer 32 in the longitudinal direction X of the seat 1, and interposed between the cushioning layer 32 and the frame 31, in particular in the longitudinal direction X of the seat 1, so as not to transmit vibrations of excessive amplitude to the user's back, the vibrations advantageously being damped, at least in part, by the cushioning layer 32 before reaching the user's back via the flexible covering layer 33, or

according to a second alternative, positioned in front of the cushioning layer 32 in the longitudinal direction X of the seat 1, and interposed between the flexible covering layer 33 and the cushioning layer 32, in particular in the longitudinal direction X of the seat 1, and so as to be as close as possible to the user's back in order to act thereon.

Advantageously, in order to reduce the size of the backrest 3, at least some of the electromechanical haptic elements 61 of the first set 6 may extend, at least partially, within the same plane as the haptic elements 41 of the first set 4 and/or as the pneumatic haptic elements 51 of the second set 5, and in particular within a plane substantially in the vertical Z and transverse Y directions of the seat 1.

Advantageously, in order to avoid generating interference between the operation of the pneumatic haptic elements 41 of the first set 4 and/or the pneumatic haptic elements 51 of the second set 5, and the electromechanical haptic elements 61 of the first set 6, the electromechanical haptic elements 61 of the first set 6 may be offset along the longitudinal direction X and/or transverse direction Y and/or vertical direction Z of the seat 1 relative to the pneumatic haptic elements 41 of the first set 4 and/or relative to the pneumatic haptic elements 51 of the second set 5.

Advantageously, and in order to avoid the risk of damaging the spine of the user when seated on the seat 1, the electromechanical haptic elements 61 of the first set 6 may be provided so as to be offset from the spine of the user when seated on the seat 1.

Advantageously, and as can be seen in FIG. 1, the first set 6 may comprise at least two electromechanical haptic elements 61, in particular aligned substantially in the transverse direction Y of the seat 1.

As can be seen in FIG. 2, the first set 6 may further comprise at least four electromechanical haptic elements 61, in particular aligned two by two substantially in the transverse direction Y of the seat 1 and/or substantially in the vertical direction Z of the seat 1.

According to one embodiment, at least some of the electromechanical haptic elements 61 of the first set 6 of electromechanical haptic elements 61 are fixed to a support part 34 of the backrest 3, the support part being fixed to the frame 31 and positioned so that the cushioning layer 32 is positioned in front of the support part 34 in the longitudinal direction X of the seat 1, and interposed between the flexible covering layer 33 and the support part 34, in particular in the longitudinal direction X of the seat 1.

Advantageously, and as can be seen in FIG. 2, the support part 34 receiving at least some of the electromechanical haptic elements 61 of the first set 6 may be the same as the one receiving at least some of the pneumatic haptic elements 51 of the second set 5, described above.

In order to reduce the size of the backrest 3, the electromechanical haptic elements 61 of the first set 6 may advantageously extend at least partially, and for at least some of them, through the support part 34.

According to one embodiment, at least some of the electromechanical haptic elements 61 of the first set 6 extend, at least partially, through the cushioning layer 32, in order to reduce the size of the backrest 3 and possibly allow the cushioning layer 32 to partially dampen the vibrations of the electromechanical haptic elements 61 of the first set 6 before reaching the user's back.

In particular, the pneumatic haptic elements 41 of the first set 4 and/or the pneumatic haptic elements 51 of the second set 5 may be positioned on the first side 32A of the cushioning layer 32, in the longitudinal direction X of the seat 1, while the electromechanical haptic elements 61 of the first set 6 may be positioned, in the longitudinal direction X of the seat 1, on the second side 32B of the cushioning layer 32.

Alternatively, the pneumatic haptic elements 41 of the first set 4 and/or the pneumatic haptic elements 51 of the second set 5 may be positioned on the same side 32A, 32B of the cushioning layer 32 as the electromechanical haptic elements 61 of the first set 6.

At least some of the electromechanical haptic elements 61 of the first set 6 may be fixed to the cushioning layer 32, for example by clipping and/or gluing and/or by a hook-and-loop fastening system such as VELCRO® for example.

According to one embodiment, the haptic system H comprises at least one independent set 4′ of pneumatic haptic elements 41 positioned at the seat base 2 of the seat 1 and/or at least one independent set 6′ of electromechanical haptic elements 61 positioned at the seat base 2 of the seat 1.

The haptic system H can thus massage the legs, and in particular the thighs and/or knees, as well as the buttocks of a user seated on the seat 1 according to the disclosure.

The frame 21 of the seat base 2 may for example be made essentially of metal. It may also be connected directly to the frame 31 of the backrest 3, by being hinged thereto along the transverse axis Y1.

The cushioning layer 22 of the seat base 2 may for example be a part comprising foam made of polymer, and in particular of polyurethane foam.

The flexible covering layer 23 of the seat base 2, schematically represented in FIGS. 1 and 2, may for example be a layer made of textile or of leather.

According to one embodiment, the haptic system H comprises a third independent set 4′ of pneumatic haptic elements 41 positioned at the seat base 2 of the seat 1, and:

according to a first alternative, positioned below the cushioning layer 22 in the vertical direction Z of the seat 1, and interposed between the cushioning layer 22 and the frame 21, in particular in the vertical direction Z of the seat 1, so as not to transmit movements of excessive amplitude to the legs and/or buttocks of the user, the movements advantageously being damped, at least in part, by the cushioning layer 22 before reaching the user's legs and/or buttocks via the flexible covering layer 23, or,

according to a second alternative, positioned above the cushioning layer 22 in the vertical direction Z of the seat 1, and interposed between the flexible covering layer 23 and the cushioning layer 22, in particular in the vertical direction Z of the seat 1, so as to be closer to the user's legs and/or buttocks in order to act thereon.

Advantageously, the pneumatic haptic elements 41 of the third set 4′ may be intended to be located substantially in the extension of the legs and/or buttocks, in particular in the vertical direction Z of the seat 1, of the user when seated on the seat 1 according to the disclosure.

Advantageously, the pneumatic haptic elements 41 of the third set 4′ may be arranged substantially within the same plane, and in particular within a plane substantially in the longitudinal X and transverse Y directions of the seat 1.

Advantageously, as can be seen in FIGS. 1 and 2, the pneumatic haptic elements 41 of the third set 4′ may, at least in part, be aligned in columns each extending substantially in the longitudinal direction X of the seat 1 and/or in rows each extending substantially in the transverse direction Y of the seat 1.

In particular, as can be seen in FIGS. 1 and 2, the pneumatic haptic elements 41 of the third set 4′ may be arranged in two columns substantially parallel to each other.

The third set 4′ can thus cover a significant portion of the legs and/or buttocks of the user when seated on the seat 1, and while using pneumatic haptic elements 41 of reduced size.

Advantageously, the third set 4′ comprises at least four pneumatic haptic elements 41, preferably at least six pneumatic haptic elements 41, and even more preferably at least eight pneumatic haptic elements 41, and in order to cover the largest possible area of the legs and/or buttocks of the user when seated on the seat 1.

According to one embodiment, at least some of the pneumatic haptic elements 41 of the third set 4′ of pneumatic haptic elements 41 are fixed to a support part 24 of the seat base 2, the support part being fixed to the frame 21 and positioned so that the cushioning layer 22 is positioned above the support part (24) in the vertical direction Z of the seat 1, and interposed between the flexible covering layer 23 and the support part 24, in particular in the vertical direction Z of the seat 1.

In order to reduce the size of the seat base 2, the pneumatic haptic elements 41 of the third set 4′ may advantageously extend at least partially, and for at least some of them, through the support part 24.

The cushioning layer 22 may be supported, at least partially, on the support part 24.

According to one embodiment, at least some of the pneumatic haptic elements 41 of the third set 4′ may extend, at least partially, through the cushioning layer 22, in order to reduce the size of the seat base 2 and possibly enable the cushioning layer 22 to partially dampen the movements of the pneumatic haptic elements 41 of the third set 4′ before reaching the user's legs and/or buttocks.

At least some of the pneumatic haptic elements 41 of the third set 4′ may be fixed to the cushioning layer 22, for example by clipping and/or gluing and/or by a hook-and-loop fastening system such as VELCRO® for example.

According to one embodiment, as can be seen in FIG. 2, the third set 4′ of pneumatic haptic elements 41 is connected to the first set 4 of pneumatic haptic elements 41.

This advantageously makes it possible to facilitate the coordination of movements between the haptic elements 41 of the first set 4 and the pneumatic haptic elements 41 of the third set 4′, for example in order to act on a user seated on the seat 1 simultaneously in the region of the user's back and legs and/or buttocks, by operating the haptic elements 41 of the first set 4 and the pneumatic haptic elements 41 of the third set 4′ in a coordinated manner.

According to one embodiment, the haptic system H comprises a second set 6′ of electromechanical haptic elements 61 positioned at the seat base 2 of the seat 1, and:

according to a first alternative, positioned below the cushioning layer 22 in the vertical direction Z of the seat 1, and interposed between the cushioning layer 22 and the frame 21, in particular in the vertical direction Z of the seat 1, so as not to transmit vibrations of excessive amplitude to the user's legs and/or buttocks, the vibrations advantageously being damped, at least in part, by the cushioning layer 22 before reaching the user's legs and/or buttocks via the flexible covering layer 23, or

according to a second alternative, positioned above the cushioning layer 22 in the vertical direction Z of the seat 1, and interposed between the flexible covering layer 23 and the cushioning layer 22, in particular in the vertical direction Z of the seat 1, and so as to be as close as possible to the user's legs and/or buttocks in order to act thereon.

Advantageously, in order to avoid generating interference between the operation of the pneumatic haptic elements 41 of the third set 4′ and the electromechanical haptic elements 61 of the second set 6′, the electromechanical haptic elements 61 of the second set 6′ may be offset along the longitudinal direction X and/or along the transverse direction Y and/or along the vertical direction Z of the seat 1 relative to the pneumatic haptic elements 41 of the third set 4′.

Advantageously, the electromechanical haptic elements 61 of the second set 6′ may be arranged substantially within a same plane, and in particular within a plane substantially in the longitudinal X and transverse Y directions of the seat 1, and preferably substantially parallel to the pneumatic haptic elements 41 of the third set 4′.

Advantageously, and in order to avoid the risk of damaging the spine of the user when seated on the seat 1, the electromechanical haptic elements 61 of the second set 6′ may be provided so as to be offset from the spine of the user when seated on the seat 1.

Advantageously, the electromechanical haptic elements 61 of the second set 6′ may be arranged, in particular in the vertical direction Z of the seat 1, substantially in the extension of the knees of a user when seated on the seat 1.

Advantageously, the second set 6′ may comprise at least two electromechanical haptic elements 61, in particular aligned substantially along the transverse direction Y of the seat 1.

According to one embodiment, at least some of the electromechanical haptic elements of the second set 6′ of electromechanical haptic elements 61 are fixed to a support part 24 of the seat base 2, the support part being fixed to the frame 21 and positioned so that the cushioning layer 22 is positioned above the support part 24 in the vertical direction Z of the seat 1, and interposed between the flexible covering layer 23 and the support part 24, in particular in the vertical direction Z of the seat 1.

Advantageously, and as can be seen in FIG. 2, the support part 24 receiving at least some of the electromechanical haptic elements 61 of the second set 6′ may be the same as the one receiving at least some of the pneumatic haptic elements 41 of the third set 4′, described above.

In order to reduce the size of the seat base 2, the electromechanical haptic elements 61 of the second set 6′ may advantageously extend at least partially, and for at least some of them, through the support part 24.

According to one embodiment, at least some of the electromechanical haptic elements 61 of the second set 6′ extend, at least partially, into the cushioning layer 22, in order to reduce the size of the seat base 2 and possibly enable the cushioning layer 22 to partially dampen the vibrations of the electromechanical haptic elements 61 of the second set 6′ before reaching the user's legs and/or buttocks.

For example, the pneumatic haptic elements 41 of the third set 4′ may be positioned on a first side 22A of the cushioning layer 22, in the vertical direction Z of the seat 1, in particular oriented towards the top of the seat 1 in the vertical direction Z of the seat 1, while the electromechanical haptic elements 61 of the second set 6′ may be positioned, in the vertical direction Z of the seat 1, on a second side 22B of the cushioning layer 22, opposite to the first side 22A, and in particular oriented towards the bottom of the seat 1 in the vertical direction Z of the seat 1.

Alternatively, the pneumatic haptic elements 41 of the third set 4′ may be positioned on the same side 22A, 22B of the cushioning layer 22 as the electromechanical haptic elements 61 of the second set 6′.

At least some of the electromechanical haptic elements 61 of the second set 6′ may be fixed to the cushioning layer 32, for example by clipping and/or gluing and/or by a hook-and-loop fastening system such as VELCRO® for example.

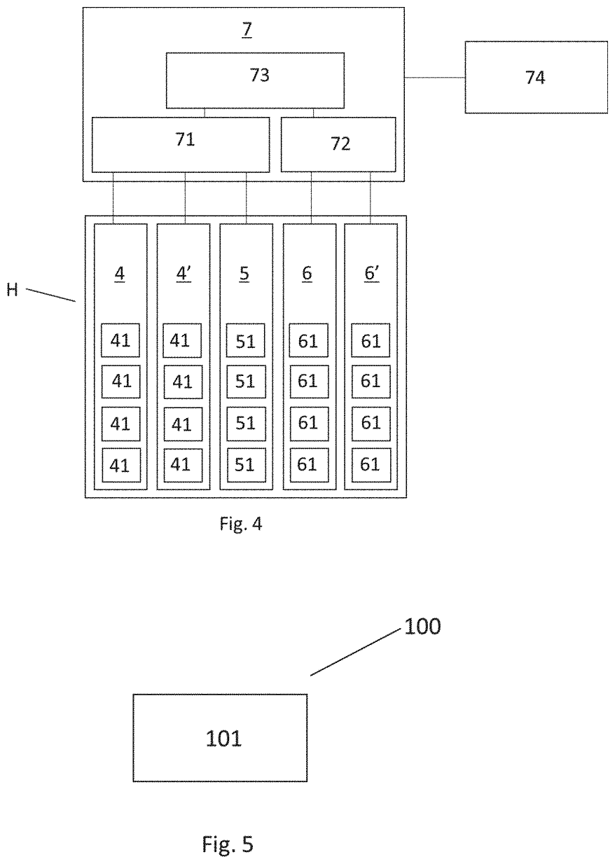

According to one embodiment, and as can be seen in FIG. 4, the seat 1 further comprises a control unit 7 connected to the haptic system H, the control unit 7 being configured to control the operation of the haptic elements 41, 51, 61 of each of the sets 4, 5, 5′, 6, 6′ independently, in order to act on a user seated on the seat 1.

The control unit 7 may be integral to the seat 1, and in particular to the frame 21 of the seat base 2 or to the frame 31 of the backrest 3. Alternatively, the control unit 7 may be placed elsewhere in a vehicle receiving the seat 1 according to the disclosure. For example, the control unit 7 may be part of a central control unit of the vehicle receiving the seat 1.

The control unit 7 may comprise a bus and addressing system making it possible to send, independently to each of the haptic elements 41, 51, 61 of the various independent sets 4, 4′, 5, 6, 6′, a control signal which causes it to operate according to a determined operating sequence (i.e. with a certain amplitude of movement or of vibration, and/or with a certain frequency of vibration, and/or with a certain duration of movement or of vibration).

The control unit 7 may for example comprise a processor capable of generating control signals intended for the various haptic elements 41, 51, 61 of the various independent sets 4, 4′, 5, 6, 6′, it being possible to convert such a digital signal output by the processor into an analog signal, by a digital-to-analog converter, and to amplify it by an amplifier in its transmission chain to the haptic element 41, 51, 61 concerned.

The control unit 7 may thus for example comprise a read-only memory in which is stored a computer program for controlling the operation of the haptic system H, as well as random access memory in which variables and registers are stored during the execution of the computer program.

The read-only memory may also store one or more operating sequences intended to be implemented by the haptic system H and such that the control signals are generated for the various haptic elements 41, 51, 61 of the various independent sets 4, 4′, 5, 6, 6′, advantageously following the actuation by a user of an actuation control connected to the control unit, and in particular by a user seated on the seat 1 according to the disclosure.

As explained above, an operating sequence may consist of the successive actuation of the various haptic elements 41, 51, 61 of the various sets 4, 4′, 5, 6, 6′, and advantageously independently of each other, in different combinations between the haptic elements 41, 51, 61 of the various sets 4, 4′, 5, 6, 6′, and each according to a determined sequence (for example, according to a certain amplitude of movement and/or of vibration, and/or with a certain frequency of vibration, and/or with a certain duration of movement or of vibration).

Alternatively, the control unit 7 may be configured so that an operating sequence is controlled in real time, in particular by a user seated on the seat 1 according to the disclosure, who can thus select in real time which haptic element(s) 41, 51, 61 of which set(s) 4, 4′, 5, 6, 6′ are actuated and/or while varying the operating sequence in real time, for example by modulating simultaneously or individually the amplitude of movement or of vibration, and/or the frequency of vibration, and/or the duration of movement or of vibration of each of the haptic elements 41, 51, 61 of the various sets 4 , 4′, 5, 6, 6′.

According to one embodiment, as can be seen in FIG. 4, the control unit 7 comprises:

a first independent control module 71, configured to control the operation of the pneumatic haptic elements 41, 51 of the or of each of the independent set(s) 4, 4′, 5 of pneumatic haptic elements 41, 51, independently of the operation of the electromechanical haptic elements 61 of the or of each of the independent set(s) 6, 6′ of electromechanical haptic elements 61, and

a second independent control module 72, configured to control the operation of the electromechanical haptic elements 61 of the or of each of the independent set(s) 6, 6′ of electromechanical haptic elements 61, independently of the operation of the pneumatic haptic elements 41, 51 of the or of each of the independent set(s) 4, 4′, 5 of pneumatic haptic elements 41, 51.

As can also be seen in FIG. 4, the first control module 71 and the second control module 72 may be interconnected by a synchronization module 73, configured to synchronize the first control module 71 and the second control module 72, and to ensure synchronized control of the operation of the pneumatic haptic elements 41, 51 of the or of each of the independent set(s) 4, 4′, 5 of independent pneumatic haptic elements 41, 51 and of the operation of the electromechanical haptic elements 61 of the or of each of the independent set(s) 6, 6′ of electromechanical haptic elements 61 of the haptic system H, in order to act on a user seated on the seat 1.

Thus, the controlling of the pneumatic haptic elements 41, 51 can be carried out independently of the controlling of the electromechanical haptic elements 61, by each independent control module 71, 72.

The first control module 71 and/or the second control module 72 and/or the synchronization module 73 may be integral to the seat 1, and in particular to the frame 21 of the seat base 2 or to the frame 31 of the backrest 3.

Alternatively, the first control module 71 and/or the second control module 72 and/or the synchronization module 73 may be arranged elsewhere in a vehicle receiving the seat 1 according to the disclosure. For example, the first control module 71 and/or the second control module 72 and/or the synchronization module 73 may be part of a central control unit of the vehicle receiving the seat 1.

The first control module 71 and/or the second control module 72 may comprise a bus and addressing system which allows sending independently to each of the pneumatic haptic elements 41, 51, 61 of the various independent sets 4, 4′, 5, respectively to each of the electromechanical haptic elements 61 of the various independent sets 6, 6′, a control signal causing it to operate according to a determined sequence (i.e. with a certain amplitude of movement or of vibration, and/or with a certain frequency of vibration, and/or with a certain duration of movement or of vibration).

The first control module 71 and/or the second control module 72 may for example comprise a processor capable of generating control signals intended for the various pneumatic haptic elements 41, 51, 61 of the various independent sets 4, 4′, 5, respectively for each of the electromechanical haptic elements 61 of the various independent sets 6, 6′, it being possible to convert such a digital signal output by the processor into an analog signal, by a digital-to-analog converter, and to amplify it by an amplifier in its transmission chain to the haptic element 41, 51, 61 concerned.

The first control module 71 and/or the second control module 72 may thus for example comprise a read-only memory in which is stored a computer program for controlling the operation of the various pneumatic haptic elements 41, 51, 61 of the various independent sets 4, 4′, 5, respectively of the various electromechanical haptic elements 61 of the various independent sets 6, 6′, as well as a random access memory in which variables and registers are stored during the execution of the computer program.

The read-only memory may also store one or more operating sequences intended to be implemented by various pneumatic haptic elements 41, 51, 61 of one or more of the various independent sets 4, 4′, 5 of pneumatic haptic elements 41, 51, respectively by various electromechanical haptic elements 61 of the various independent sets 6, 6′ of electromechanical haptic elements 61, and so as to generate the control signals for the various pneumatic haptic elements 41, 51, 61 of the various independent sets 4, 4′, 5, respectively to each of the electromechanical haptic elements 61 of the various independent sets 6, 6′, advantageously following the actuation by a user of an actuation control, connected to the control unit, and in particular by a user seated on the seat 1 according to the disclosure.

The synchronization module 73 may comprise a bus and addressing system making it possible to send a control signal independently to each of the control modules 71, 72.

The synchronization module 73 may for example comprise a processor capable of generating control signals intended for each of the control modules 71, 72, it being possible to convert such a digital signal output by the processor into an analog signal, by a digital-to-analog converter, and to amplify it by an amplifier in its transmission chain to the control module 71, 72 concerned.

The synchronization module 73 may thus for example comprise a read-only memory in which is stored a computer program for synchronization of the control modules 71, 72, as well as a random access memory in which variables and registers are stored during the execution of the computer program.

According to one embodiment, the control unit 7 is configured for:

controlling the operation of the pneumatic haptic elements 41, 51 of the at least one set 4, 5, 5′ of pneumatic haptic elements 41, 51 as a function of a first characteristic C1 of an audio stream playing near the seat 1, and in particular by means of the first control module 71, and/or

controlling the operation of the electromechanical haptic elements 61 of the at least one set 6 of electromechanical haptic elements 6 as a function of the first characteristic C1 of the audio stream playing near the seat 1 and/or as a function of a second characteristic C2, different from the first characteristic C1, of the audio stream playing near the seat 1, and in particular by means of the second control module 72.

For this purpose, the control unit 7 may comprise for example a module for generating control signals for the various haptic elements 41, 51, 61 of the various independent sets 4, 4′, 5, 6, 6′ as a function of the first C1 and/or second characteristic C2 of the audio stream playing near the seat 1.

Thus, the control unit 7 can control the operation of the haptic elements 41, 51, 61 of the various independent sets 4, 4′, 5, 6, 6′ in a manner coordinated with an audio stream playing near the seat 1, and in order to act on a user seated on the seat 1 coordinated with an audio stream playing near the seat 1, so as to provide the user with an improved massage to better relax him or her.

Indeed, an action on a user involving the coordinated operation of the haptic elements 41, 51, 61 of the various independent sets 4, 4′, 5, 6, 6′ with an audio stream playing near the seat 1 makes it possible to provide an immersive haptic multisensory experience to a user seated on the seat 1.

In particular, using measurements with an EEG as described above, that by playing relaxing music near the seat 1 and by operating the haptic elements 41, 51, 61 of the various sets 4, 4′, 5, 6, 6′ in a coordinated manner, the relaxation of a user seated on the seat 1 was improved compared to that of a user having simply benefited from the action of the haptic elements 41, 51, 61 of the various independent sets 4, 4′, 5, 6, 6′, without relaxing music playing near the seat 1.

Advantageously, an audio streaming device 74 may be placed near the seat 1 according to the disclosure. For example, such an audio streaming device 74 may be integral to the frame 31 of the backrest 3 or to the frame 21 of the seat base 2.

The audio streaming device 74 may in particular be connected to the control unit 7. It may for example comprise at least one speaker, as well as an amplifier. The audio streaming device 74 may also consist of an external device such as a smartphone, a tablet, or a computer.

The first C1 and/or the second characteristic C2 of the audio stream may for example be stored in a memory of the control unit 7, and for example in a memory of the first control module 71, and/or in a memory of the second control module 72, and/or in a memory of the synchronization module 73, and in particular in a read-only memory as described above, in which one or more audio files intended to be playing by the audio streaming device 74 may also advantageously be stored. The audio stream may also be received from wired or wireless communication means.

Alternatively, the first C1 and/or second characteristic C2 of the audio stream may be determined in real time by the control unit 7, and for example by the first control module 71 and/or the second control module 72 and/or the synchronization module 73, and in particular according to an algorithm implemented by a computer program for controlling the operation of the haptic system H, as described above. To this end, the control unit 7, respectively the first control module 71 and/or the second control module 72 and/or the synchronization module 73, may for example be connected to a sound capturing means, such as a microphone for example, in order to capture an audio stream playing near the seat 1 and determine the first C1 and/or second characteristic C2 of the audio stream.

The audio stream may for example consist of the soundtrack of a video game, film, or piece of music, or consist of an audio stream received by streaming via a network that may or may not be local.

The first C1 and/or second characteristic C2 of the audio stream may consist of:

the tempo of the audio stream, and/or

the transitions between the verses and the chorus, and/or

the frequency or frequencies of the audio stream, and/or

the detection of a note.

For example, if the first C1 or second characteristic C2 of the audio stream is the frequency of a track of an audio stream playing near the seat 1, the control unit 7 may send a control signal to one or more electromechanical haptic elements 61 of the first 6 and/or second set 6′ so as to cause them to vibrate at a substantially identical frequency.

Similarly, if the first C1 or second characteristic C2 of the audio stream is the tempo of a piece of music constituting the audio stream playing near the seat 1, the control unit 7 may send a control signal to one or more pneumatic haptic elements 41, 51 of the first 4 and/or second 5 and/or third set 4′ so as to give them a movement having a substantially identical tempo.

The disclosure also relates, as can be seen in FIG. 5, to a method 100 for controlling a seat 1 according to one of the embodiments of the disclosure, comprising at least one step 101 of operating one or more haptic elements 41, 51, 61 of one or more independent sets of haptic elements 4, 5, 5′, 6, 6′ of the haptic system H of a user, according to a determined operating sequence, so as to massage a user seated on the seat 1.

All of the provisions described above concerning the operation of the seat 1 according to the disclosure, and in particular its haptic system H, apply to the method according to the disclosure, alone or in combination.

In particular, step 101 may also comprise, in the same manner as previously described:

controlling the operation of the pneumatic haptic elements 41, 51 of at least one set 4, 5, 5′ of pneumatic haptic elements 41, 51 as a function of a first characteristic C1 of an audio stream playing near the seat 1, and/or

controlling the operation of the electromechanical haptic elements 61 of at least one set 6 of electromechanical haptic elements 6 as a function of the first characteristic C1 of the audio stream playing near the seat 1 and/or as a function of a second characteristic C2 of the audio stream playing near the seat 1.

The disclosure lastly relates to a vehicle equipped with a seat 1 according to one of the embodiments of the disclosure described above.

The vehicle may in particular be a motor vehicle.

All of the provisions described above concerning a vehicle receiving a seat 1 according to the disclosure apply to the vehicle according to the disclosure, alone or in combination.

A vehicle generally comprises at least one seat intended to accommodate a driver or a passenger of the vehicle, hereinafter referred to as the user. The seat may be intended to accommodate a single person or several people seated side by side, and may be arranged at the front or at the rear of the vehicle.

Thus, within the meaning of the disclosure, the term seat according to the disclosure designates both a front seat of the vehicle and a rear seat of the vehicle. Similarly, the disclosure may be implemented for seats intended for any type of vehicle and in particular for motor vehicles.

A vehicle seat may comprise a seat base intended to accommodate at least one user, and configured to be connected to the floor of a vehicle, for example by means of two slide rails, arranged one on either side of the seat base in the transverse direction of the seat and configured to allow the sliding of the seat relative to the floor of the vehicle in the longitudinal direction of the seat.

The seat may also comprise at least one backrest, hinged in a pivoting manner along a transverse axis of the seat to the seat base, generally at its rear edge.

Some comparative vehicle seats may be provided with haptic elements integrated into the backrest and/or the seat base of the seat and intended to be in contact, in particular via a flexible covering layer and possibly a cushioning layer, with a user seated on the seat. These haptic elements may also be intended to operate according to different operating sequences in order to act on the user seated on the seat, in particular in order to enable the user to relax.

Nevertheless, the sensation felt by the user during the operation of haptic elements may not be relaxing, or may even create discomfort for the user.

Throughout this application, the term haptic element is understood to mean a controllable element, possibly with variable intensity, and which can be felt by the body of a user. For example, it may be an element designed to exert pressure, or a vibrating element.

The disclosure overcomes the shortcomings of comparative vehicle seats by proposing a vehicle seat equipped with haptic elements, making it possible to improve the relaxation of a user of the seat.

Another object of the disclosure is to provide such a vehicle seat that is of simple design and reduced production cost.

A vehicle seat is proposed comprising:

a seat base intended to be fixed to the floor of a vehicle, and comprising a rigid frame, a flexible covering layer intended to receive and support the legs and/or buttocks of a user, as well as a cushioning layer interposed between the flexible covering layer and the frame,

a backrest pivotably hinged to the seat base along a transverse axis of the seat, and comprising a rigid frame, a flexible covering layer intended to receive and support the back of a user, as well as a cushioning layer interposed between the flexible covering layer and the frame,

a haptic system, comprising:

at least one independent set of pneumatic haptic elements each comprising at least one pneumatic haptic element, positioned at the backrest and/or the seat base, and

at least one independent set of electromechanical haptic elements each comprising at least one electromechanical haptic element, positioned at the backrest and/or the seat base.

According to optional features of the disclosure, taken alone or in combination:

the pneumatic haptic element or elements are expandable elements, intended to increase their volume when a fluid is introduced therein and to decrease their volume when the fluid is extracted therefrom;

the electromechanical haptic element or elements are vibrating elements, intended to vibrate at a determined frequency and/or amplitude when electrically powered;

the haptic system comprises at least one independent set of pneumatic haptic elements and/or at least one independent set of electromechanical haptic elements, both positioned at the seat backrest;

the haptic system comprises a first independent set of pneumatic haptic elements positioned at the seat backrest, in front of the cushioning layer in the longitudinal direction of the seat, and interposed between the flexible covering layer and the cushioning layer of the backrest;

the pneumatic haptic elements of the first set are, at least in part, aligned in columns each extending substantially in the vertical direction of the seat and/or in rows each extending substantially in the transverse direction of the seat;

the first set comprises at least eight pneumatic haptic elements, preferably at least twelve pneumatic haptic elements, and even more preferably at least sixteen pneumatic haptic elements;

the haptic system comprises a second independent set of pneumatic haptic elements positioned at the seat backrest, and: according to a first alternative, positioned behind the cushioning layer in the longitudinal direction of the seat, and interposed between the cushioning layer and the frame, or, according to a second alternative, positioned in front of the cushioning layer in the longitudinal direction of the seat, and interposed between the flexible covering layer and the cushioning layer;

at least some of the pneumatic haptic elements of the second set of pneumatic haptic elements are fixed on a support part of the backrest, the support part being fixed to the frame and positioned so that the cushioning layer is positioned in front of the support part in the longitudinal direction of the seat, interposed between the flexible covering layer and the support part, the support part being for example a suspension layer of the backrest or being integral with such a suspension layer;

at least some of the pneumatic haptic elements of the second set extend, at least partially, through the cushioning layer;

the second set of pneumatic haptic elements is configured as a lumbar support for a user of the seat, the second set comprising in particular three pneumatic haptic elements substantially parallel to each other, with two adjacent pneumatic haptic elements partially superimposed one over the other substantially in the vertical direction of the seat;

the haptic system comprises a first independent set of electromechanical haptic elements positioned at the seat backrest, and: according to a first alternative, positioned behind the cushioning layer in the longitudinal direction of the seat, and interposed between the cushioning layer and the frame, or, according to a second alternative, positioned in front of the cushioning layer in the longitudinal direction of the seat, and interposed between the flexible covering layer and the cushioning layer;

at least some of the electromechanical haptic elements of the first set of electromechanical haptic elements are fixed on a support part of the backrest, the support part being fixed to the frame and positioned so that the cushioning layer is positioned in front of the support part in the longitudinal direction of the seat, and interposed between the flexible covering layer and the support part;

at least some of the electromechanical haptic elements of the first set extend, at least partially, through the cushioning layer;

the haptic system comprises at least one independent set of pneumatic haptic elements positioned at the seat base of the seat and/or at least one independent set of electromechanical haptic elements positioned at the seat base of the seat;

the haptic system comprises a third independent set of pneumatic haptic elements positioned at the seat base of the seat, and: according to a first alternative, positioned below the cushioning layer in the vertical direction of the seat, and interposed between the cushioning layer and the frame, or, according to a second alternative, positioned above the cushioning layer in the vertical direction of the seat, and interposed between the flexible covering layer and the cushioning layer;

at least some of the pneumatic haptic elements of the third set of pneumatic haptic elements are fixed on a support part of the seat base, the support part being fixed to the frame and positioned so that the cushioning layer is positioned above the support part in the vertical direction of the seat, and interposed between the flexible covering layer and the support part;

at least some of the pneumatic haptic elements of the third set extend, at least partially, through the cushioning layer;

the third set of pneumatic haptic elements is connected to the first set of pneumatic haptic elements;

the haptic system comprises a second set of electromechanical haptic elements positioned at the seat base of the seat, and: according to a first alternative, positioned below the cushioning layer in the vertical direction of the seat, and interposed between the cushioning layer and the frame, or, according to a second alternative, positioned above the cushioning layer in the vertical direction of the seat, and interposed between the flexible covering layer and the cushioning layer;

at least some of the electromechanical haptic elements of the second set of electromechanical haptic elements are fixed to a support part of the seat base, the support part being fixed to the frame and positioned so that the cushioning layer is positioned above the support part in the vertical direction of the seat, and interposed between the flexible covering layer and the support part;

at least some of the electromechanical haptic elements of the second set extend, at least partially, into the cushioning layer;

the seat further comprises a control unit connected to the haptic system, the control unit being configured to control the operation of the haptic elements of each of the sets independently so as to act on a user seated on the seat;

the control unit is configured for: controlling the operation of the pneumatic haptic elements of the at least one set of pneumatic haptic elements as a function of a first characteristic of an audio stream playing near the seat, and/or controlling the operation of the electromechanical haptic elements of the at least one set of electromechanical haptic elements as a function of the first characteristic of the audio stream playing near the seat and/or as a function of a second characteristic, different from the first characteristic, of the audio stream playing near the seat.

According to another aspect, a method is proposed for controlling a seat according to one of the embodiments of the disclosure, comprising at least one step of operating one or more haptic elements of one or more independent sets of haptic elements of the haptic system of a user according to a determined operating sequence, so as to act on a user seated on the seat.

According to one embodiment of the method, the step also comprises:

controlling the operation of the pneumatic haptic elements of the at least one set of pneumatic haptic elements as a function of a first characteristic of an audio stream playing near the seat, and/or

controlling the operation of the electromechanical haptic elements of the at least one set of electromechanical haptic elements as a function of the first characteristic of the audio stream playing near the seat and/or as a function of a second characteristic of the audio stream playing near the seat.

Finally, a vehicle equipped with a seat according to one of the embodiments of the disclosure is proposed.

The features discussed in the following paragraphs may optionally be implemented. They may be implemented independently of each other or in combination with each other.

1. A vehicle seat comprising:
a seat base intended to be fixed to the floor of a vehicle, and comprising a rigid frame, a flexible covering layer intended to receive and support the legs and/or buttocks of a user, as well as a cushioning layer interposed between the flexible covering layer and the frame,
a backrest pivotably hinged to the seat base along a transverse axis of the seat, and comprising a rigid frame, a flexible covering layer intended to receive and support the back of a user, as well as a cushioning layer interposed between the flexible covering layer and the frame,
a haptic system, comprising:
at least one independent set of pneumatic haptic elements each comprising at least one pneumatic haptic element, positioned at the backrest and/or the seat base,
at least one independent set of electromechanical haptic elements each comprising at least one electromechanical haptic element, positioned at the backrest and/or the seat base, the electromechanical haptic elements being vibrating elements, intended to vibrate at a determined frequency and/or amplitude when electrically powered, and
a control unit connected to the haptic system, the control unit being configured to control the operation of the haptic elements of each of the sets independently so as to act on a user seated on the seat, in order to transmit vibrations to the user's body via the electromechanical haptic elements and/or to provide a massaging effect to the user via the pneumatic haptic elements.

2. The vehicle seat of claim 1, wherein the pneumatic haptic element or elements are expandable elements, intended to increase their volume when a fluid is introduced therein and to decrease their volume when the fluid is extracted therefrom.

3. The vehicle seat of claim 1, wherein the haptic system comprises at least one independent set of pneumatic haptic elements and/or at least one independent set of electromechanical haptic elements, both positioned at the backrest of the seat.

4. The vehicle seat of claim 3, wherein the haptic system comprises a first independent set of pneumatic haptic elements positioned at the backrest of the seat, in front of the cushioning layer in the longitudinal direction of the seat, and interposed between the flexible covering layer and the cushioning layer of the backrest.

5. The vehicle seat of claim 4, wherein the pneumatic haptic elements of the first set are, at least in part, aligned in columns each extending substantially in the vertical direction of the seat and/or in rows each extending substantially in the transverse direction of the seat.

6. The vehicle seat of claim 4, wherein the first set comprises at least eight pneumatic haptic elements, preferably at least twelve pneumatic haptic elements, and even more preferably at least sixteen pneumatic haptic elements.

7. The vehicle seat of claim 3, wherein the haptic system comprises a second independent set of pneumatic haptic elements positioned at the backrest of the seat, and:
according to a first alternative, positioned behind the cushioning layer in the longitudinal direction of the seat, and interposed between the cushioning layer and the frame, or
according to a second alternative, positioned in front of the cushioning layer in the longitudinal direction of the seat, and interposed between the flexible covering layer and the cushioning layer.

8. The vehicle seat of claim 7, wherein the haptic system comprises the second independent set of pneumatic haptic elements positioned at the backrest of the seat, and positioned behind the cushioning layer in the longitudinal direction of the seat, and interposed between the cushioning layer and the frame, and wherein at least some of the pneumatic haptic elements of the second set of pneumatic haptic elements are fixed on a support part of the backrest, the support part being fixed to the frame and positioned so that the cushioning layer is positioned in front of the support part in the longitudinal direction of the seat, interposed between the flexible covering layer and the support part, the support part being for example a suspension layer of the backrest or being integral with such a suspension layer.

9. The vehicle seat of claim 7, wherein at least some of the pneumatic haptic elements of the second set extend, at least partially, through the cushioning layer.

10. The vehicle seat of claim 7, wherein the second set of pneumatic haptic elements is configured as a lumbar support for a user of the seat, the second set comprising in particular three pneumatic haptic elements substantially parallel to each other, with two adjacent pneumatic haptic elements partially superimposed one over the other substantially in the vertical direction of the seat.

11. The vehicle seat of claim 1, wherein the haptic system comprises a first independent set of electromechanical haptic elements positioned at the backrest of the seat, and:
according to a first alternative, positioned behind the cushioning layer in the longitudinal direction of the seat, and interposed between the cushioning layer and the frame, or
according to a second alternative, positioned in front of the cushioning layer in the longitudinal direction of the seat, and interposed between the flexible covering layer and the cushioning layer.

12. The vehicle seat of claim 11, wherein at least some of the electromechanical haptic elements of the first set of electromechanical haptic elements are fixed on a support part of the backrest, the support part being fixed to the frame and positioned so that the cushioning layer is positioned in front of the support part in the longitudinal direction of the seat, and interposed between the flexible covering layer and the support part.

13. The vehicle seat of claim 11, wherein at least some of the electromechanical haptic elements of the first set extend, at least partially, through the cushioning layer.

14. The vehicle seat of claim 1, wherein the haptic system comprises at least one independent set of pneumatic haptic elements positioned at the seat base of the seat and/or at least one independent set of electromechanical haptic elements positioned at the seat base of the seat.

15. The vehicle seat of claim 14, wherein the haptic system comprises a third independent set of pneumatic haptic elements positioned at the seat base of the seat, and:
according to a first alternative, positioned below the cushioning layer in the vertical direction of the seat, and interposed between the cushioning layer and the frame, or
according to a second alternative, positioned above the cushioning layer in the vertical direction of the seat, and interposed between the flexible covering layer and the cushioning layer.

16. The vehicle seat of claim 15, wherein the haptic system comprises the third independent set of pneumatic haptic elements positioned at the seat base of the seat, and positioned below the cushioning layer in the vertical direction of the seat, and interposed between the cushioning layer and the frame, and wherein at least some of the pneumatic haptic elements of the third set of pneumatic haptic elements are fixed on a support part of the seat base, the support part being fixed to the frame and positioned so that the cushioning layer is positioned above the support part in the vertical direction of the seat and interposed between the flexible covering layer and the support part.

17. The vehicle seat of claim 15, wherein at least some of the pneumatic haptic elements of the third set extend, at least partially, through the cushioning layer.

18. The vehicle seat of claim 15, wherein the third set of pneumatic haptic elements is connected to the first set of pneumatic haptic elements.

19. The vehicle seat of claim 14, wherein the haptic system comprises a second set of electromechanical haptic elements positioned at the seat base of the seat, and:
according to a first alternative, positioned below the cushioning layer in the vertical direction of the seat, and interposed between the cushioning layer and the frame, or
according to a second alternative, positioned above the cushioning layer in the vertical direction of the seat, and interposed between the flexible covering layer and the cushioning layer.

20. The vehicle seat of claim 19, wherein at least some of the electromechanical haptic elements of the second set of electromechanical haptic elements are fixed to a support part of the seat base, the support part being fixed to the frame and positioned so that the cushioning layer is positioned above the support part in the vertical direction of the seat, and interposed between the flexible covering layer and the support part.

21. The vehicle seat of claim 19, wherein at least some of the electromechanical haptic elements of the second set extend, at least partially, into the cushioning layer.

22. The vehicle seat of claim 1, wherein the control unit is configured for:
controlling the operation of the pneumatic haptic elements of the at least one set of pneumatic haptic elements as a function of a first characteristic of an audio stream playing near the seat, and/or
controlling the operation of the electromechanical haptic elements of the at least one set of electromechanical haptic elements as a function of the first characteristic of the audio stream playing near the seat and/or as a function of a second characteristic, different from the first characteristic, of the audio stream playing near the seat.

23. A method for controlling the vehicle seat according to claim 1, comprising at least one step of operating one or more haptic elements of one or more independent sets of haptic elements of the haptic system of a user according to a determined operating sequence, so as to act on a user seated on the seat.

24. The method of claim 23, wherein step also comprises:
controlling the operation of the pneumatic haptic elements of the at least one set of pneumatic haptic elements as a function of a first characteristic of an audio stream playing near the seat, and/or
controlling the operation of the electromechanical haptic elements of the at least one set of electromechanical haptic elements as a function of the first characteristic of the audio stream playing near the seat and/or as a function of a second characteristic of the audio stream playing near the seat.

25. A vehicle equipped with the vehicle seat according to claim 1.
